(19) United States
(12) Patent Application Publication
(10) Pub. No.: US 2010/0263949 A1
(43) Pub. Date: Oct. 21, 2010

(54) Motorized Platform

(76) Inventor: Jerry Dean Horn, Hilliard, OH (US)

Correspondence Address: Jerry D. Horn, 3091 Stouenburgh Drive, Hilliard, OH, 43026, US

(21) Appl. No.: 12/757,741

(22) Filed: Apr. 9, 2010

Related U.S. Application Data
(60) Provisional application No. 61/170,513, filed on Apr. 17, 2009.

(51) Int. Cl. B62D 51/02; B62D 61/06

(52) U.S. Cl. 180/14.1; 180/216

(57) ABSTRACT

A multi-wheeled, self-propelled device that alters an existing walk behind caddy in that the operator stands on a motorized platform while holding onto an assembly which is attached to the handlebar of said walk behind golf caddy. The self-propelled device is temporarily attached to the bottom portion of the walk behind golf caddy. The power supply and motor remain part of the platform and the control (throttle/brake) remains part of the attached handlebar assembly.

### PREVIOUS FILING

This application emanates from a previous application filing dated Apr. 17, 2009; application No. 61/170,513

### FIELD OF THE INVENTION

This invention relates generally to golf carts, and particularly to golf carts of the type that are designed to be stood upon and driven in a manner like that of driving a motorized chariot.

### BACKGROUND OF THE INVENTION

As is known, there is a large need for small driven vehicles, which can carry only a single person and a small amount of relatively light cargo. Such vehicles can be used, for example, by messengers, for parts delivery in large industrial plants, or as golf carts. The usual golf cart will accommodate at least two individuals and, as a consequence, is relatively large and bulky, at least too large to be carried in the trunk of an automobile. This means that most golf carts are owned by golf courses or country clubs and rented to players. Furthermore, the size of a conventional golf cart, which is usually battery powered, necessitates the use of a relatively large drive motor and other heavy components, including the batteries. As a result, the initial cost of such carts is high as is the rental which must be charged for their use.

In view of such, there is a need for a lightweight golf cart which will accommodate a single golfer, which can be bought or rented cheaply, and which can be folded and placed in an automobile trunk if desired whereby the golfer can buy their own cart and need not to rent one each time they play.

Attempts have been made to develop small golf carts to provide individual golfers with a motorized means for conveying the golfer and his or her golf bag about a golf course. Exemplary of such attempts are those golf carts shown in U.S. Pat. Nos. 3,369,629, 4,522,281, 4,538,695 and 4,573,549. These designs have focused on providing a small, lightweight golf cart that may be collapsed for storage and transportation. Some have also been designed for use by a golfer walking beside the cart as well as riding upon it.

Though the concepts and basic design goals just described have been good, their implementations have not. As a result chariot type golf carts have failed to achieve popularity. Their lack of commercial success has been principally due to the difficulty of devising a golf cart with both the desired degree of versatility and simplicity of design. As a result, some desirable features have almost invariably had to be sacrificed.

For example, the golf cart illustrated in U.S. Pat. No. 3,369,629 does have the attributes of having an articulated handlebar that may be moved between riding, walking and storage positions. It however is essentially a conventional, heavy, seat bearing cart with only side access and which requires the golfer to sit closely aside one or between two golf bags. Also when only one bag is carried, as would often occur with a one-person cart, the center of gravity of the cart is shifted to one side of center line thereby adversely affecting stability. The cart of U.S. Pat. No. 4,522,281 on the other hand is of simpler and of lighter construction in that it does not have a seat and which does provide a detachable club mount that is on center line. It however cannot easily be mounted from the rear nor can it be easily operated while walking.

The cart of U.S. Pat. No. 4,538,695 does have rear mounting, is lightweight and is designed to be operated while walking. These features however are achieved at the sacrifice of center line bag mounting, structural and aesthetic complexity, and an inability to be configured compactly for storage. The U.S. Pat. No. 4,573,549 cart has similar design tradeoffs in that it is without center line bag mounting and walk-beside operative capabilities.

It thus is seen that a need remains for a sulky type golf cart of simple, lightweight and high stability configuration that may easily be configured for storage, riding or walking. It is to the provision of such therefore that the present invention is directed.

### SUMMARY OF THE INVENTION

The object of the present invention is to provide a battery-operated, motorized platform that attaches to a new or used existing walk-behind golf caddy by which a handlebar easily attaches to the grip of the walk-behind caddy and consists of a throttle and a brake which controls the operation of the multi-wheeled platform. This allows the golfer to stand and ride on the platform from one shot to the next while using the cart path. The device may or may not remain on the cart path (depending on course conditions) while the golfer goes to the ball location or the golfer can walk beside the device as it pulls itself using the throttle. This device will be useful for those golfers who can't or do not want to walk as much or can't or do not want to rent a golf cart. The device consists of several pieces for ease of transportation and is easy to assemble. This device does not prevent the walk-behind caddy from being utilized in its' original state if so chosen.

The purpose of this invention is to provide a platform with multiple wheels attached, propelled by an electric motor by which handle bars are attached easily to an existing walk-behind golf caddy. The left side has a brake cable and a motor inhibit switch, the right side has the throttle which controls the acceleration. The cables are Velcro strapped to the existing walk-behind caddy. The brake cable goes to one of the wheels, the motor inhibit and throttle cables go to the control console. The console has cables that connect to the battery compartment which is beneath the platform. To attach the platform to the bottom rear of the walk-behind golf caddy a “quick connect” hitch adapter is used. This allows the tongue to be attached to the rear of the walk behind caddy, which allows for 360 degrees of pivoting. The body of the platform (what one stands on) is attached permanently to the tongue. The wheels are held onto the body of the platform similar to a bicycle wheel. The motor drives the wheels. The control console houses the on/off switch and charging port. The control module is mounted underneath the platform next to the batteries.

### BRIEF DESCRIPTION OF THE DRAWINGS

FIG. 1 See figures on same page

### DETAILED DESCRIPTION OF THE DRAWINGS

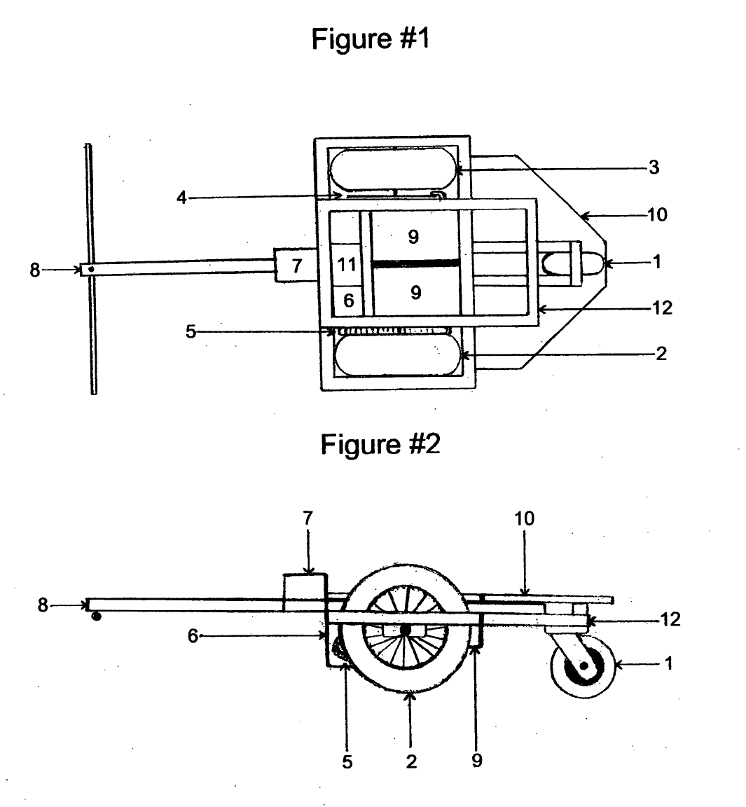

FIG. 1 is the top view and FIG. 2 is the side view of the device whereas the swivel pin (8) attaches to the tongue of the frame (12). The control console (7) is mounted to the tongue of the frame giving access to the charging port and on/off switch which is all part of the control console (7). The control console (7) and throttle are electrically connected to the controller (11), which supplies voltage from the batteries (9) to the motor (6). The motor (6) is connected to the drive tire (2) by way of the chain (5). To provide braking of the platform, the disc brake (4) is activated by a cable lever on the throttle assembly, which will control the brake tire (3). The platform cover (10) is on top of the frame (12), which allows the rider a solid surface to stand on, and it protects the batteries (9), controller (11), motor (6) and disc brake (4). The swivel tire (1) is attached to the frame (12), which enhances stability and allows it to easily pivot 360 degrees.

What is claimed is:

1. A motorized platform apparatus for use with a walk behind golf caddy having first and second wheels separated by a standing platform body and additionally having a third swivel wheel located to the rear of first and second wheels, said platform suitable for carrying a person while connected to and pushing golf clubs, comprising:
a. motor means for moving said first and second wheels of said cart;
b. control console means for enabling in a first mode of operation said motor means to control cart movement by a cart operator;
c. a tongue and frame assembly for attachment to said golf club caddy
d. portable, rechargeable electrical power supply
e. braking system
f. standing platform

2. A motorized platform apparatus of claim 1 wherein; the apparatus is a separate operational unit from the golf bag or rolling caddy or cart.

3. A motorized platform apparatus of claim 1 wherein; the platform is adaptable to multiple brands of walk behind caddies.

4. A motorized platform apparatus of claim 1 wherein; the platform is portable.

5. A motorized platform apparatus of claim 1 wherein; the platform is powered by electrical energy.

6. A motorized platform apparatus of claim 1 wherein; a pivoting hitch allows for wide directional angles.

7. A motorized platform apparatus of claim 1 wherein; the platform is manufactured of lightweight metallic materials.

8. A motorized platform apparatus of claim 1 wherein; the platform is low to the ground for easy access.

9. A motorized platform apparatus of claim 1 wherein; the platform utilizes pneumatic tires.
